(19) United States
(12) Patent Application Publication
(10) Pub. No.: US 2019/0234524 A1
(43) Pub. Date: Aug. 1, 2019

(54) PLATE-LESS INLET VALVE

(71) Applicant: Ingersoll-Rand Company, Davidson, NC (US)

(72) Inventors: Chandramouli Attili, Bangalore (IN); Mallikarjun J. Jambigi, Bangalore (IN)

(21) Appl. No.: 15/885,021

(22) Filed: Jan. 31, 2018

(51) Int. Cl. F16K 17/06; F16K 31/06; F16K 21/12; F16K 13/10

(52) U.S. Cl. CPC F16K 17/065; F16K 13/10; F16K 21/12; F16K 31/0651

(57) ABSTRACT

A plate-less inlet valve assembly having a support frame, flexible conduit, and control assembly. Opposing ends of the flexible conduit are coupled to the relatively rigid support frame. The flexible conduit can include an inner wall that generally defines at least a pathway that accommodates a flow of working fluid through the flexible conduit. A size of a restriction within a portion of the pathway can be selectively adjusted so as to control the flow of working fluid through the pathway. The restriction can generally assist with providing the pathway with an adjustable venturi shape. The control assembly can be coupled to the flexible conduit and configured to provide a force to selectively adjust the size of the restriction. Additionally, the control assembly can be positioned outside of the direct path of working fluid in the pathway such that working fluid in the pathway does not flow around the control assembly.

### BACKGROUND

Embodiments of the present application generally relate to an inlet valve to control an inlet flow of a fluid. More particularly, but not exclusively, embodiments of the present application relate to an inlet valve that generally forms a venturi using control components that are positioned outside of a flow path of the fluid.

Traditionally, at least certain types of inlet valves control the supply of an incoming fluid by adjusting the location of, or the extent that, a moveable plate or barrier of the inlet valve is positioned directly in the pathway of the flow, if any, of the incoming fluid. For example, inlet valves for air compressors often control an incoming flow of ambient air through the use of a throttle plate or piston that generally resides directly in the pathway of the air flow. According to such designs, the control of the supply of airflow typically generally involves adjusting the position of throttle plate or piston within the pathway of the airflow to control the size of the associated restriction within the inlet valve. Thus, with such designs, the passage of the air through the inlet valve typically involves the incoming air flow having to flow around at least a portion of the throttle plate or piston.

The presence of such plates and positions, among other barriers or obstacles in the pathway of the incoming air flow can result in the development of local low pressures in the inlet valve and/or the associated system, as well as create relatively high-pressure drops across the restriction. In at least compression applications, the associate compression module typically has to work against such pressure differences created by the inlet valve to compress the fluid, such as air, to a pre-determined pressure. Thus, the compression module often has to perform additional work to compensate for the pressure differences created by such traditional inlet valves, which can adversely impact the efficiency of the compressor. Additionally, such inlet valves typically are designed and/or sized to accommodate a specific, and generally limited, capacity, which can at least limit the number of applications that each particular designed or sized inlet valve can be used. Further, the presence of such barriers within the air pathway can facilitate contaminants, including, but not limited to oil and/or debris, that is/are on such barriers being transferred from the barrier and into the passing flow of the inlet fluid. Further, the passage of air around such barriers in the pathway can generate sounds that can increase the level of noise generated during the operation of the associated device.

### BRIEF SUMMARY

An aspect of an embodiment of the present application is an apparatus comprising a support frame, a flexible conduit, and a control assembly. The flexible conduit can include a first end, a second end, and an inner wall, the inner wall defining a pathway within the flexible conduit. Further, the first and second ends of the flexible conduit can be at opposing ends of the flexible conduit and coupled to the support frame. The control assembly can be coupled to the flexible conduit and configured to provide a force to selectively adjust a size of a restriction formed by the inner wall within a portion of the pathway. Further, according to certain embodiments, the control assembly is external to, and not positioned within, the pathway.

Another aspect of an embodiment of the present application is an apparatus having a flexible conduit that can have an inner wall and an outer wall, the inner wall defining at least a portion of a pathway through the flexible conduit. The apparatus can also include a control assembly having a plurality of clamps and one or more actuators, the plurality of clamps being coupled to a portion of the flexible conduit. The one or more actuators can be configured to selectively displace the plurality of clamps between at least a first position and a second position to adjust a distance between opposing portions of the inner wall at a throat area of the pathway. Further, the pathway can have a venturi shape at least when opposing portions of the inner wall at the throat area are separated by a distance. Further, according to certain embodiments, the control assembly is positioned external to, and not positioned within, the pathway.

Another aspect of an embodiment of the present application is a method for operating an inlet valve of a compressor system that includes determining, using a system controller of a compressor system, a pressure of a working fluid within the compressor system, and activating, in response to the pressure determination of the system controller, a control assembly of the inlet valve. The method can further include displacing, in response to the activation of the control assembly, a portion of an inlet valve to adjust a size of a restriction within a pathway of the inlet valve. Additionally, at least when opened, the pathway has a venturi shape. Further, according to certain embodiments, the control assembly is positioned external to, and not positioned within, the pathway.

### BRIEF DESCRIPTION OF THE DRAWINGS

The description herein makes reference to the accompanying figures herein like reference numerals refer to like parts throughout the several views.

FIG. 1 illustrates a perspective side view of an exemplary plate-less inlet valve assembly according to an embodiment of the present application.

FIG. 2 illustrates a cross sectional view of a portion of an exemplary plate-less inlet valve assembly according to an embodiment of the present application.

FIG. 3 illustrates a cross sectional schematic representation of an exemplary plate-less inlet valve assembly in a closed position according to an embodiment of the present application.

FIG. 4 illustrates a cross sectional schematic representation the exemplary plate-less inlet valve assembly shown in FIG. 3 in an intermediate open position.

FIG. 5 illustrates a cross sectional schematic representation the exemplary plate-less inlet valve assembly shown in FIG. 3 in an open position.

FIG. 6 illustrates a schematic of an exemplary single stage, direct cooled rotary screw compressor system having a plate-less inlet valve assembly according to an embodiment of the present application.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

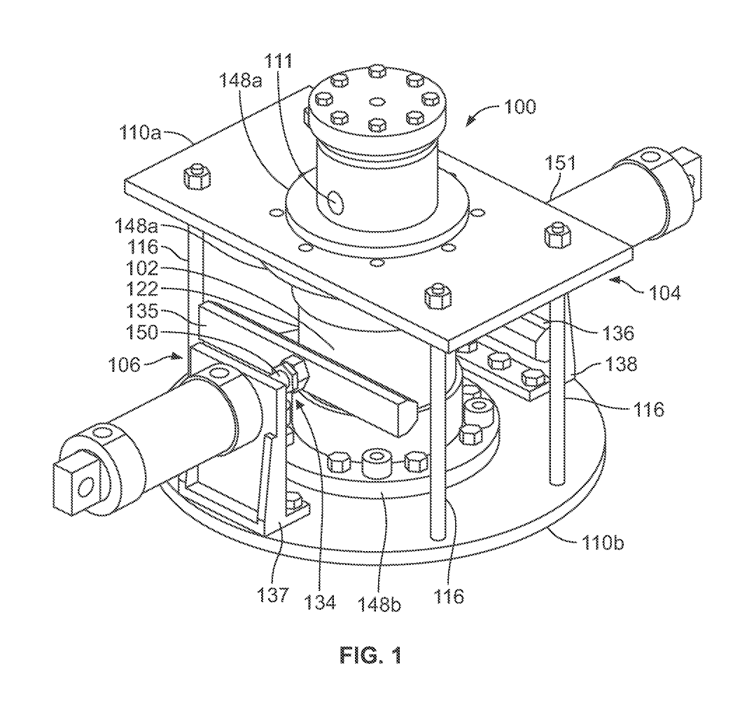

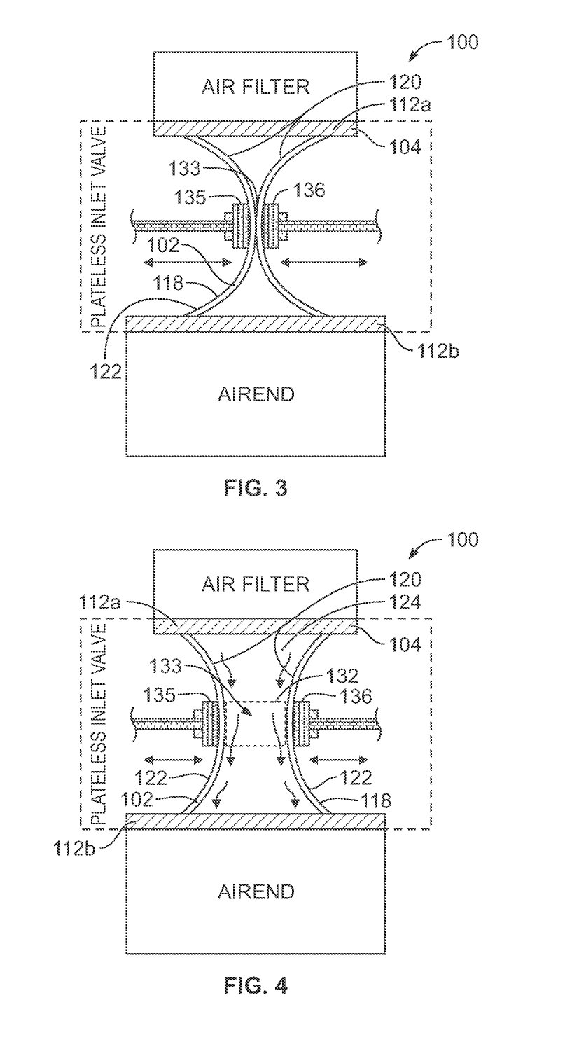

FIG. 1 illustrates a perspective side view of an exemplary plate-less inlet valve assembly 100 according to an embodiment of the present application. As illustrated, the plate-less inlet valve assembly 100 can include a flexible conduit 102, a support frame 104, and a control assembly 106. According to certain embodiments, the support frame 104 can be coupled to an outer housing 108 (FIG. 3) that encases at least a portion of the flexible conduit 102, control assembly 106, and/or support frame 104. Additionally, as illustrated, at least a portion of the control assembly 106 can be mounted to the support frame 104.

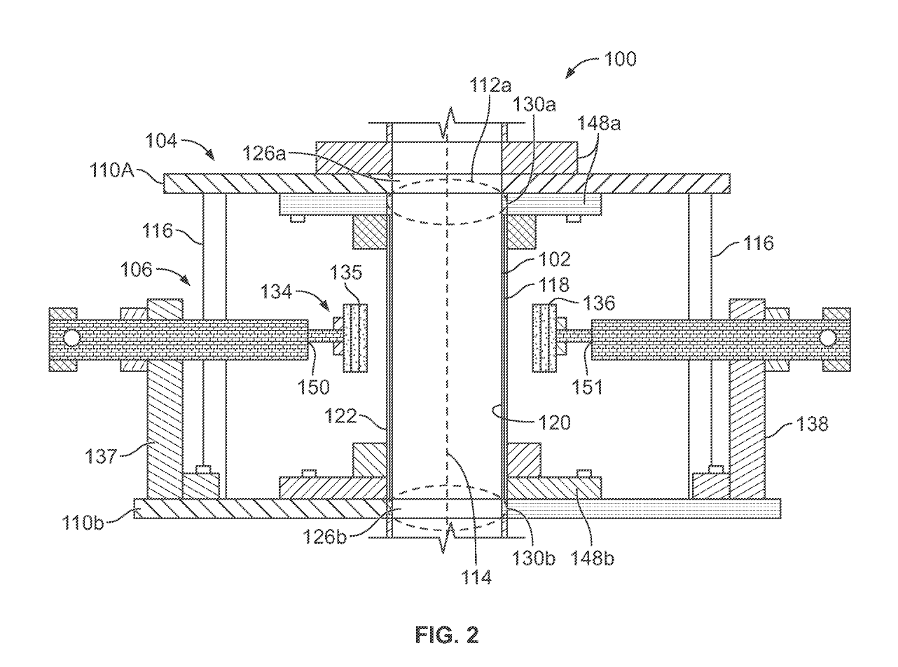

According to the illustrated embodiments, the support frame 104 includes a first end plate 110a and a second end plate 110b, the first and second end plates 110a, 110b being positioned at opposing ends of the support frame 104. Both the first and second end plates 110a, 110b can include apertures 112a, 112b (FIG. 2) that are sized and positioned to accommodate a passage of an inlet working fluid flow, such as, for example, a flow of ambient air, through at least an air inlet 111 of the flexible conduit 102. Thus, the aperture 112a of the first end plate 110a can be in fluid communication with the aperture 112b of the second end plate 110b. Moreover, according to the illustrated embodiment as shown in FIG. 2, the apertures 112a, 112b of the first and second end plates 110a, 110b can be generally axially aligned along a central longitudinal axis 114 of the plate-less inlet valve assembly 100.

The support frame 104 can include one or more supports 116 that extend between at least the first and second end plates 110a, 110b, and which can be constructed to generally rigidly support at least a portion of the plate-less inlet valve assembly 100. For example, according to certain embodiments, the supports 116 can comprise one or more posts or walls, among other structures, that provide structural support for the plate-less inlet valve assembly 100, including, for example, generally maintaining a linear distance between at least the first and second end plates 110a, 110b. The first and second end plates 110a, 110b can be secured to the supports 116 in a variety of manners, including, for example, via mechanical connectors, including, but not limited to, one or more bolts, nuts, screws, and/or threaded connections, among other manners of securing the supports 116 to the end plates 110a, 110b. For example, according to certain embodiments, at least portions of the supports 116 can include a male thread that mates with an internal thread of the adjacent first and second end plates 110a, 110b, and/or mates with other internal threaded members at or around the first and second end plates 110a, 110b. However, while the foregoing provides certain examples, the first and second end plates 110a, 110b can be secured, or otherwise coupled, to the supports 116 of the support frame 104 in a variety of other manners.

The flexible conduit 102 can include a conduit wall 118 having an inner wall 120 and an outer wall 122. The inner wall 120 can generally define a pathway 124 through the flexible conduit 102. Further, the conduit wall 118 can extend between a first end 126a and a second end 126b of the flexible conduit 102, the first and second ends 126a, 126b being on opposing ends of the conduit wall 118. According to the illustrated embodiment, the flexible conduit 102 can have a generally cylindrical configuration that extends along the central longitudinal axis 114 of the plate-less inlet valve assembly 100. plate-less inlet valve assembly 100 Further, while the flexible conduit 102 is shown in FIGS. 1 and 2 as having a generally cylindrical configuration, the flexible conduit 102 can have a variety of other configurations and shapes, as well as combinations of different shapes.

The flexible conduit 102 can be constructed from a variety of different materials and/or combinations of materials. For example, according to certain embodiments, the flexible conduit 102 can comprise an elastomer, such as, for example, a rubber, among other materials that may seek to at least assist, or otherwise accommodate, the flexible conduit 102 with returning to an initial shape and/or orientation after the flexible conduit 102 has been, or is being, released from one or more deformed shapes or other orientations. Further, according to certain embodiments, the flexible conduit 102, may, or may not, be generally dependent on a positioning of the control assembly 106 to return the flexible conduit 102 to an initial shape and/or position after the flexible conduit 102 has been, or is being, released from another deformed shape and/or position. Further, according to certain embodiments, the flexible conduit 102 can comprise a combination of materials in which one or more materials have a higher degree of flexibility and/or elasticity than other materials that provide a force that at least assists at least a portion of the flexible conduit 102 with returning to an initial shape and/or orientation after the flexible conduit 102 has been, or is being, released from forces that may have facilitated at least a portion of the flexible conduct 100 being in another, deformed shape and/or at a different orientation.

The flexible conduit 102 can be securely coupled to the support frame 104. For example, according to the illustrated embodiment, opposing first and second ends 126a, 126b of the flexible conduit 102 can be relatively securely coupled to each of the first and second end plates 110a, 110b, respectively, such as, for example, by use one or more retention bodies 130a, 130b of the support frame 104. The retention bodies 130a, 130b may, or may not, be integral portions of the associated first and second end plates 110a, 110b, or can be other portions of the support frame 104. For example, according to the illustrated embodiment, the retention body 130a in the form of a first flange or collar can inwardly extend from a portion of the first end plate 110a in general proximity to the first aperture 112a, and be sized to be positioned about, or in relative close proximity to, at least a portion of an inner wall 120 of the flexible conduit 102. For example, according to certain embodiments, the retention body 130a can be positioned about an inner perimeter of at least a portion of the inner wall 120 at or around the first end 126a of the flexible conduit 102. Similarly, according to the illustrated embodiment, the retention body 130b in the form of a second flange or collar can inwardly extend from a portion of the second end plate 110b in proximity to the second aperture 112b and be sized to be positioned about, or in relative close proximity to, at least another portion of the inner wall 120 of the flexible conduit 102. For example, similar to the other retention body 130a, the retention body 130b can be positioned about an inner perimeter of the inner wall 120 at or around the second end 126b of the flexible conduit 102.

The engagement between the flexible conduit 102 and the retention bodies 130a, 130b can be secured in a variety of manners. For example, according to certain embodiments in which the retention bodies 130a, 130b are first and second flanges that are configured to be positioned about, or against, an inner perimeter of a portion of the inner wall 120 of the flexible conduit 102, the retention bodies 130a, 130b and/or at least the corresponding portion of the inner wall 120 of the flexible conduit 120 can have a size(s), such as, for example, diameter(s), that allow the flexible conduit 102 to be stretched over the first and second retention bodies 130a, 130b. According to certain embodiments, the elasticity of the flexible conduit 102 can be used to create a force against the retention bodies 130a, 130b that can at least assist in retaining the flexible conduit 102 in relatively secure engagement with the retention bodies 130a, 130b, and thus with the support frame 104. Alternatively, or additionally, the flexible conduit 102 can be secured to the retention bodies 130a, 130b via use of an adhesive, clamp(s), and/or a mechanical fastener(s), such as, for example, a pin, bolt, or screw. For example, according to certain embodiments, the flexible conduit 102 can be coupled to the retention bodies 130a, 130b via hose clamps that compress at least a portion of the flexible conduit 102 about, and to, the retention bodies 130a, 130b.

According to the illustrated embodiments, the first and second endplates 110a, 110b of the support frame 104 can be coupled to first and second guide plates 148a, 148b, respectively. The first guide plate 148a can be positioned circumferentially about a portion of the conduit wall 118 of the conduit 102 in general proximity to the first end 126a. Similarly, the second guide plate 148b can be positioned circumferentially about a portion of the conduit wall 118 of the conduit 102 in general proximity to the second end 126b. Further, according to certain embodiments, the first and second guide plates 148a, 148b can provide alignment and additional structural support for the flexible conduit 102 to adjoin the support frame 104. In certain embodiments, the first and second guide plates 148a, 148b can be coupled to the first and second endplates 110a, 110b of the support frame 104 via use of an adhesive, clamp(s), and/or a mechanical fastener(s), such as, for example, a pin, bolt, or screw, among other connections.

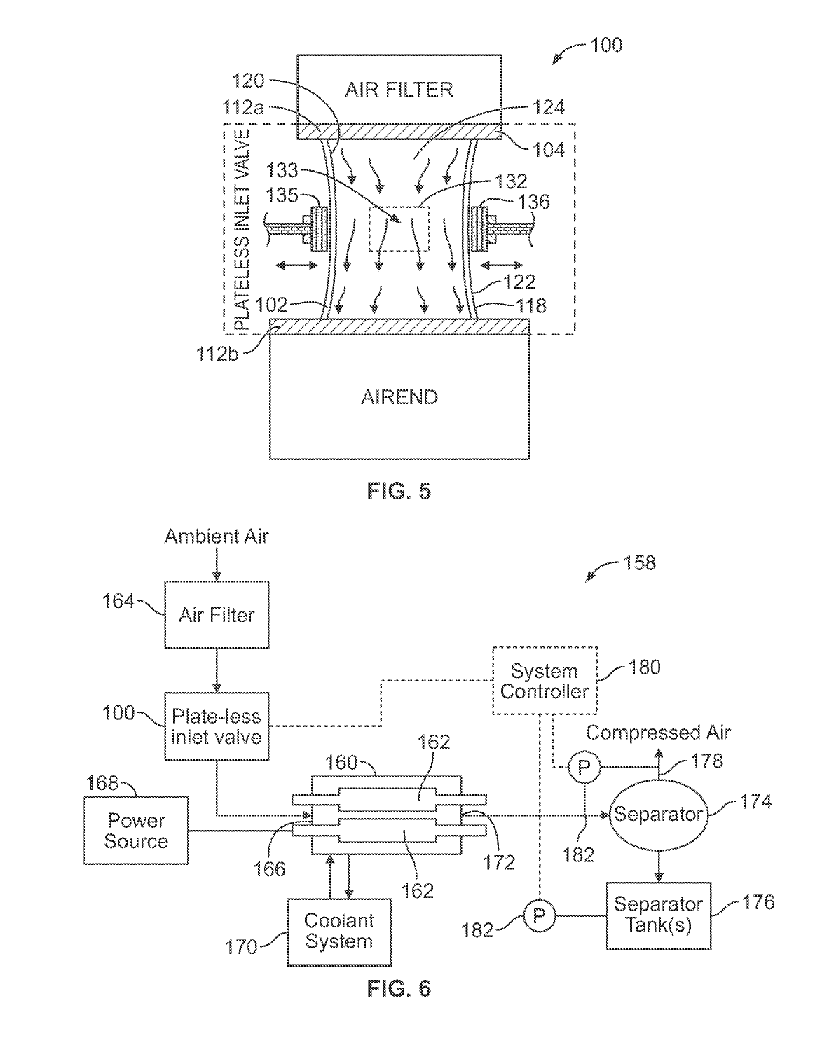

The control assembly 106 can be configured to selectively provide a force that changes a size of a restriction 133 contained within the pathway 124, and/or adjust the size of an associated throat area 132 of the pathway 124 that can be positioned between and/or around opposing sides of the restriction 133, in a manner that can allow the flexible conduit 102 to at least act or function at least close to a venturi. For example, as shown by at least FIGS. 3-5, according to certain embodiments, the control assembly 106 can provide a force that is exerted against a portion of the conduit wall 118 of the flexible conduit 102, such as the outer wall 122, that adjusts the relative proximity of opposing sides of a portion of the inner wall 120 to each other so as to adjust the size of a constriction, or restriction, and the associated throat area 132, in the pathway 124. For example, for at least purposes of illustration, the exemplary throat area 132, depicted in FIG. 4 between at least a portion of an expanded restriction 133, is generally shown at midsection between the first and second ends 126a, 126b of the flexible conduit 102, and is illustrated as an area enclosed in the broken lines. The exemplary throat area 132 is transposed over a portion of the larger throat area 132′ in FIG. 5 to provide an exemplary indication of possible selective changes in the size of throat area 132, 132′, and/or the size of the associated restriction, provided by operation of the control assembly 106, and moreover, controls over the amount, or flow, of working fluid that passes through the flexible conduit 102. Further, while the throat area 132 is depicted in FIGS. 4 and 5 as being generally at a midsection of a longitudinal length of the flexible conduit 102, the throat area 132 can be at a variety of other locations along the flexible conduit 102. Further, the throat area 132 can have a variety of cross-sectional shapes a sizes, including, for example, being generally circular, oval, and non-circular, among other aerodynamic shapes and combinations thereof.

As shown by at least FIGS. 4 and 5, according to certain embodiments, despite changes in the size of the throat area 132 of the pathway 124, other portions of the flexible conduit 102, such as, for example, portions of the flexible conduit 102 at and around the first and second ends 126a, 126b of the flexible conduit 120 can retain larger sizes, such as, for example, larger diameters. Such configurations can accommodate the flexible conduit 102 providing a shape that at least assists in providing a venturi type or shaped pathway 124 through the flexible conduit 102 through which a working fluid can flow. Additionally, as indicated by FIGS. 3-5, the control assembly 106 can reside outside of this venturi type or shaped pathway 124. Moreover, the control assembly 106 can be positioned relative to at least the pathway 124, including, for example, outside or external to the pathway 124, such that working fluid does not directly flow around the control assembly 106 as the working fluid flows through the pathway 124. Such venturi shaping of the pathway 124, as well as the absence of the control assembly 106 in the direct path of the working fluid flowing through the pathway 124 can facilitate a reduction in, if not almost negligible, pressure drop in the working fluid that passes through the flexible conduit 102, as well as preventing the formation of eddy or recirculation in the pathway 124. As a consequence, the flexible conduit 102 can assist in improving the efficiency of the associated equipment, such as, for example a compressor that is coupled to the plate-less inlet valve assembly 100, as well as contribute to a reduction in operation noise.

According to certain embodiments, the flexible conduit 102 and/or the control assembly 106 can be configured to be normally in a closed position, as shown, for example, by FIG. 3. Further, according to certain embodiments, when the plate-less inlet valve assembly 100 is in the closed position, opposing sides of the inner walls 120 of the conduit wall 118 at and/or around the throat area 132 can be in contact, and/or in relatively close proximity, with each other so as to at least attempt to prevent, or minimize, the flow of working fluid through the flexible conduit 102. Thus, according to certain embodiments, when in the closed position, the plate-less inlet valve assembly 100 can provide a relatively complete restriction at least at the throat area 132 that at least attempts to prevent the flow of working fluid through the throat area 132 of the pathway 124 and/or which isolates the second end 126b of the flexible conduit 102 generally from portions of the flexible conduit 102 on the other side of the throat area 132 or associated restriction 133. Further, according to such embodiments, the plate-less inlet valve assembly 100 can be assembled to the associated device, machine, or tool, such as, for example, the compressor, in such a closed state so as to prevent the passage of inlet working fluid through the flexible conduit 102.

According to certain embodiments, including, for example, embodiments in which the flexible conduit 102 is normally in the closed position, the control assembly 106 can be configured to selectively at least provide a generally outwardly directed force on the flexible conduit 102, and moreover, on the conduit wall 118 at or around the vicinity of the throat area 132, that can expand or increase, or otherwise adjust, the size or area of the throat area 132, and thus the size of the restriction 133 therein, so as to adjust the quantity of working fluid that can pass through the throat area 132 and/or through the flexible conduit 102. For example, according to certain embodiments, the control assembly 106, including, for example, the below discussed clamp system 134, can be coupled to, or otherwise in engagement with, the flexible conduit 102 so as to provide a generally outwardly directed force at or around the throat area 132 of the flexible conduit 102, such as for example, to at least a portion of a perimeter or circumference of the conduit wall 118 at or around a midsection of a longitudinal length of the flexible conduit 102, in a manner that can facilitate the displacement, bending, deformation, and/or deflection at least a portion of the conduit wall 118 in a generally outwardly direction. For example, according to certain embodiments, the below discussed clamp system 134 can be connected to, or otherwise coupled to, the conduit wall 118 such that generally outwardly displacement, or release, of the clamp system 134, can result in a generally outwardly directed pulling force being exerted against the conduit wall 118. Such force(s) against the flexible conduit 102 can at least assist in displacing opposing sides of a portion of the inner wall 120 of the flexible conduit 102 at or in the vicinity of the throat area 132 away from each other so as to increase the size, such as, for example, the area, of the throat area 132, and/or reduce or eliminate the restriction 133 within the throat area 132.

The flexible conduit 102 can return from an open position, such as, for example, from the positions illustrated in FIGS. 4 and 5, as well as other open positions, to a closed position, as shown for example in FIG. 3, in a variety of different manners. For example, according to certain embodiments, the control assembly 106 can exert a generally inwardly directed force(s), such as, for example, inwardly directing or engaging the below-discussed clamps 135, 136 of the clamp system 134 with the conduit wall 118, so that a force(s) is/are generally directed toward the central longitudinal axis 114 of the plate-less inlet valve assembly 100 in a manner that brings at least a portion of opposing portions of the inner wall 120 at or around the throat area 132 into contact with each other so as to prevent or minimize the flow of working fluid through the throat area 132 and/or to isolate the pathway 124 around the second end 126b of the flexible conduit 102 from at least the portion of the pathway 124 at or around the first end 126a of the flexible conduit 102. Additionally, or alternatively, the flexible conduit can be constructed, such as, for example have a shape or configuration as well as be constructed from a material(s) having a resiliency that returns the flexible conduit 102, and moreover the throat area 132, to the closed position. Further, according to certain embodiments, the flexible conduit 102, such as, for example, the outer wall 122 can be subjected to a force from one or more biasing elements, such as, for example, springs, that can return the flexible conduit 102 to the closed position.

While the foregoing examples are described in terms of the flexible conduit 102 normally being in the closed position, according to certain embodiments, the flexible conduit 102 can be in a normally open position, as shown for example by FIGS. 2 and 5. According to such embodiments, the control assembly 106 can be coupled to the flexible conduit 102 and operated to at least selectively decrease a size of the throat area 132, and thereby increase the restriction 133 therein, as well as hold and/or maintain the plate-less inlet valve assembly 100 in the closed position, as shown for example in FIG. 3. For example, similar to at least certain embodiments in which the control assembly 106 returns the flexible conduit 102 from an open position to a normally closed position, according to certain embodiments in which the flexible conduit is normally in an open position, the control assembly 106 can be coupled to, or otherwise engageble with, the flexible conduit 102 so as to exert a radially inwardly directed force around at least a portion of a circumference or perimeter of the flexible conduit 102, such as, for example, against a portion of a circumference about the outer wall 122 that is located generally around a longitudinal midsection of the flexible conduit 102. Such an inwardly directed force(s) can at least assist in deforming, bending, deflecting, and/or otherwise displacing at least a portion of the conduit wall 118 that is generally at, or in the vicinity, of at least the throat area 132 so that at least portions of corresponding opposing portions of the inner wall 120 are moved into contact with, or closer proximity to, each other that a restriction 133 is provided in the throat area 132 that prevents the passage of working fluid through the flexible conduit 102. Further, again, according to such embodiments, the control assembly 106 is configured to adjust a size of the throat area 132 without positioning any portion of the control assembly 106 in the direct path of the working fluid flow that flows through at least the throat area 132 of the flexible conduit 102. Moreover, according to the illustrated embodiments, the control assembly 106 can be positioned outside of the inlet flow path of working fluid that flows through the flexible conduit 102.

The control assembly 106 can selectively adjust the size of the throat area 132, and thus the corresponding restriction 133, in a variety of different manners. For example, as shown in FIGS. 1 and 2, according to certain embodiments, the control assembly 106 can include at least a clamp system 134, first and second actuators 150, 151, and brackets 137, 138. The control assembly 106 can be configured to provide a force(s) to the flexible conduit 102 that can facilitate the above-discussed selective changes or adjustments in the size, such as, for example, a diameter, of the throat area 132 of the pathway 124 of the flexible conduit 102, and thus the size of the associated restriction 133.

According to certain embodiments, the clamp system 134 can include a plurality of clamps, such as, for example, a first clamp 135 and a second clamp 136, among other clamps. According to the illustrated embodiment, the first clamp 134 can be coupled to a first bracket 137, and a second clamp 136 coupled to a second bracket 138, the first and second brackets 137, 138 each being be coupled to the second end plate 110b. The first and second brackets 137, 138 can be coupled to the end plate 110b in a variety of manners, including, for example, via mechanical connectors, including, but not limited to, one or more bolts, nuts, screws, inter-locking connectors, and/or threaded connections, among other manners of coupling the first and second brackets 137, 138 to the end plate 110b. For example, according to certain embodiments, at least portions of the first and second brackets 137, 138 can include male threads or inter-locking connectors that mate with internal threads of the adjacent second end plate 110b, and/or which mate with other internal threaded members or other inter-locking connectors at or around the second end plate 110b. However, while the foregoing provides certain examples, the second end plate 110b can be coupled, or otherwise secured, to the first and second brackets 137, 138 of the control assembly 106 in a variety of other manners.

The first and second actuators 150, 151 are configured to control the displacement of the first and second clamps 135, 136 of the clamp system 134, respectively, between a first, inner or engaged position and the second, outer or released position, as well as to positions therebetween. Moreover, selective operation of the actuators 150, 151, and thus associated control of the position(s) of the clamps 135, 136, can control a size of the throat area 132 and associated restriction 133 of the flexible conduit 102. The first and second actuators 150, 151 can comprise a variety of different types of components and/or assemblies to facilitate the movement, such as, for example, linear displacement, of the clamps 135, 136 of the clamp system 134. For example, according to certain embodiments, the first and second actuators 150, 151 can be pneumatic circuits that include one or more pneumatically actuated pistons, drivers, cylinders, and/or motors that are attached or otherwise coupled to the first and second clamps 135, 136. According to such embodiments, the pneumatic circuit can be configured to convert compressed air or hydraulics into mechanical power, such as, for example, via expansion of at least a portion of a pneumatically actuated piston, that can push at least a portion of the clamp system 134 in a manner that facilitates displacement of the first and second clamps 135, 136 of the clamp system 134 toward at least one of the first, inner position and the second, outer position. Alternatively, according to other embodiments, the first and second actuators 150, 151 can include an electric circuit that has one or more magnetic coils and/or one or more electrically actuated pistons that are configured to provide a magnetic or mechanical force used to facilitate the linear displacement of the clamp system 134.

Further, according to alternative embodiments, rather than utilizing both first and second actuators 150, 151, one single actuator can be configured to control the displacement of both the first and second clamps 135, 136 of the clamp system 134 between the first, inner position and the second, outer position, as well as to positions therebetween, and thereby be used in connection with controlling a size of the throat area 132 and associated restriction 133 of the flexible conduit 102. Additionally, or alternatively, according to certain embodiments, at least a portion of the clamps 135, 136 can be attached to the conduit wall 118, such as, for example, via an adhesive, coupling, or mechanical fastener, including bolts, screws, and pins, among other manners of coupling the clamps 135, 136 to the flexible conduit 102.

While the forgoing example describes an embodiment in which the control assembly 106 comprises a clamp system 134 including first and second actuators 150, 151 and first and second claims 135, 136, the clamp system 134 can take a variety of other forms. For example, the clamp system 134 can include selectively displaceable arms or jaws, among other control members, that can be positioned against, or otherwise coupled to, the conduit wall 118 of the flexible conduit 102 in a manner that can facilitate selective displacement of at least a portion of the conduit wall 118 in a manner that can facilitate selective changes or adjustments in the size of the throat area 132 and/or the associated restriction 133, while also at least assisting in forming a venturi type or shaped pathway 124.

According to the illustrated embodiment, the plate-less inlet valve assembly 100 can be part of, or otherwise coupled to, an air compressor. For example, FIGS. 3-5 illustrate the plate-less inlet valve assembly 100 positioned between an air filter 164 and an airend 155. Additionally, FIG. 6 illustrates a schematic of an exemplary single stage, direct cooled rotary screw compressor system 158 that is configured to compress a working fluid, such as, for example, ambient air, and which includes the plate-less inlet valve assembly 100. According to the illustrated example, the rotary screw compressor system 158 includes a compressor housing 160 that houses at least a portion of a plurality of screw compressor rotors 162. An inlet flow of working fluid passes through an air filter 162 and the plate-less inlet valve assembly 100, and can be delivered to an inlet side 166 of a compressor chamber within the compressor housing 160. A power source 168 can be operably coupled to the screw compressor rotors 162 to provide power for the rotational displacement of the screw compressor rotors 162 in a manner that cause the compression of the working fluid, which, in this example, is ambient air.

In an attempt to remove at least some heat generated by the compression of the working fluid, according to certain embodiments, a coolant, such as, for example water or a water based coolant, from a coolant system 170 can be circulated into and/or about the compressor housing 160. The compressed working fluid, as well as at least some coolant, can exit a discharge side 172 of the compressor housing 160 and delivered to a separator 174 that can be configured to withdraw coolant, contaminates, or other items or materials from the compressed working fluid. The removed coolant and/or contaminants can be delivered to one or more separator tanks 176, while the separated compressed working fluid can be discharged from the rotary screw compressor system 158 via an outlet line 178 so that the compressed working fluid can be delivered to machinery and/or equipment that may utilize and/or store the compressed working fluid.

According to certain embodiments, the compressor system 158 can include a system controller 180 that is communicatively coupled to the control assembly 106, and, moreover, to the first and second actuators 150, 151 of the control assembly 106. According to such embodiments, the system controller 180 can provide instructions and/or information used to operate the control assembly 106. Moreover, information or instructions provided by the system controller 180 can be used to operate the first and second actuators 150, 151, and thus the clamp system 134, so as to change the size of the throat area 132 and thus the associated restriction 133, and thereby change or adjust the amount of inlet working fluid flow, if any, that passes through the flexible conduit 102. For example, according to certain embodiments, the system controller 180 can be in communication with one or more sensors 182, such as, for example, pressure and/or flow sensors, that provide information regarding the inlet and/or compressed working fluid at one or more locations about the compressor system 158. For example, according to the exemplary compressor system 158 depicted in FIG. 6, the system controller 180 receives information from a sensor 182, such as, for example, a pressure sensor, at or around the separator 174 or separator tanks 176, and/or a sensor 182, such as, for example, a pressure sensor positioned along the outlet line 178. The information provided by the sensors 182 can be evaluated by the system controller 180, such as, for example, in connection with determining whether the information provided indicates a pressure at that location that does, or does not, satisfy a predetermined pressure value or range of pressure values. For example, according to certain embodiments, the pressure information obtained by the sensors 182 may be evaluated, such as by the system controller 180, to determine whether the plate-less inlet valve assembly 100 should be adjusted, and/or if there is a demand for such an adjustment, so as to change the amount of working fluid that is, or is not, to flow through the flexible conduit 102 and be subsequently be delivered to the inlet side 166 of the compressor housing 160. Additionally, according to certain embodiments, in the absence of demand for an inlet flow of working fluid, the system controller 180 can be configured to have the plate-less inlet valve assembly 100 in a closed position to prevent, or at least minimize, the passage of working fluid through the plate-less inlet valve assembly 100.

The system controller 180 can also be configured to detect, or receive information indicating, at least potentially hazardous situations. According to such embodiments, the system controller 180 can provide an emergency or safeguard response that seeks to operate the control assembly 106 in a manner that restricts the throat area 132 to a degree that seeks to prevent, and/or minimize, the passage of working fluid flow through the flexible conduit 102. For example, the system controller 180 can provide instructions to the control assembly 106 to operate the first and second actuators 150, 151 in a manner that generally closes the throat area 132, and thereby prevents the flow of working fluid past the throat area 132, thereby generally isolating the second end 126b of the flexible conduit 102 from the first end 126a of the flexible conduit 102a.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. An apparatus comprising:
a compressor housing having a plurality of rotors;
a support frame;
a flexible conduit in fluid communication with the compressor and having a first end, a second end, and an inner wall, the inner wall defining a pathway within the flexible conduit, the first and second ends being at opposing ends of the flexible conduit and coupled to the support frame; and
a control assembly coupled to the flexible conduit and configured to provide a force to selectively adjust a size of a restriction formed by the inner wall within a portion of the pathway, and wherein the control assembly is external to, and not positioned within, the pathway.

2. The apparatus of claim 1, wherein the control assembly does not extend into a throat area of the pathway, the throat area being an open area of the pathway positioned at least between a portion of the restriction.

3. The apparatus of claim 1, wherein the pathway has an adjustable venturi shape.

4. The apparatus of claim 1, wherein the control assembly comprises a first clamp, a second clamp, and one or more actuators, the first and second clamps being at opposing sides of the flexible conduit, the one or more actuators being coupled to the first and second clamps and configured to linearly displace the first and second clamps in at least one of an inward direction and an outward direction in relation to the flexible conduit.

5. The apparatus of claim 4, wherein the first and second clamps selectively adjust the size of the restriction formed by the inner wall within the portion of the pathway.

6. The apparatus of claim 5, wherein the one or more actuators comprise a pneumatic circuit having one or more pneumatically actuated pistons.

7. The apparatus of claim 5, wherein the one or more actuators comprise an electronic circuit having one or more electronic motors.

8. The apparatus of claim 1, wherein the support frame includes a first end plate, a second end plate, and a plurality of supports, the first and second end plates being at opposing ends of the plurality of supports, the first end of the flexible conduit being coupled to the first end plate, and the second end of the flexible conduit being coupled to the second end plate.

9. The apparatus of claim 1, wherein the pathway of the flexible conduit is in fluid communication with an inlet side of the compressor housing.

10. An apparatus comprising:
a compressor housing having a plurality of rotors;
a flexible conduit in fluid communication with the compressor and having an inner wall and an outer wall, the inner wall defining at least a portion of a pathway through the flexible conduit; and
a control assembly comprising a plurality of clamps and one or more actuators, the plurality of clamps being coupled to a portion of the flexible conduit, the one or more actuators configured to selectively displace the plurality of clamps between at least a first position and a second position to adjust a distance between opposing portions of the inner wall at a throat area of the pathway,
wherein the pathway has a venturi shape at least when opposing portions of the inner wall at the throat area are separated by a distance, and
wherein the control assembly is positioned external to, and not positioned within, the pathway.

11. The apparatus of claim 10, wherein the plurality of clamps includes at least two clamps positioned on opposing sides of the flexible conduit, and wherein the one or more actuators are coupled to the plurality of clamps, the plurality of clamps being configured to be linearly displace by operation of at least the one or more actuators in at least one of an inward direction and an outward direction in relation to the flexible conduit.

12. The apparatus of claim 11, wherein the one or more actuators comprise at least one of (a) a pneumatic circuit having one or more pneumatically actuated pistons, (b) an electronic circuit having one or more electronic motors, and (c) an electromagnetic coil.

13. The apparatus of claim 10, further including a support frame, the support frame having a first end plate, a second end plate, and a support, the first and second end plates being mounted to opposing ends of the support, a first end of the flexible conduit coupled to the first end plate and a second end of the flexible conduit coupled to the second end plate, and wherein the first and second end plates each include an aperture that is in fluid communication with the pathway.

14. The apparatus of claim 10, wherein the pathway of the flexible conduit is in fluid communication with an inlet side of the compressor housing.

15.-20. (canceled)
